(19) United States
(12) Patent Application Publication
(10) Pub. No.: US 2022/0106042 A1
(43) Pub. Date: Apr. 7, 2022

(54) System and Method for Passenger Ordering System Integrated with Third Party Vendors

(71) Applicant: Aviation Nutrition Network Investment Holding LTD, Abu Dhabi (AE)

(72) Inventor: Thomas Eliopoulos, II, Fairfax Station, VA (US)

(21) Appl. No.: 17/494,073

(22) Filed: Oct. 5, 2021

Related U.S. Application Data
(60) Provisional application No. 63/087,484, filed on Oct. 5, 2020.

(51) Int. Cl. B64D 11/00; G06Q 10/02; G06F 16/9535

(52) U.S. Cl. CPC B64D 11/0007; G06F 16/9535; G06Q 10/02

(57) ABSTRACT

A method, system, and computer program product is provided for placing an order in-transit using a mobile application for a passenger ordering system. The method includes receiving a passenger name record (PNR) as an input from a user and verifying that the user is a confirmed passenger based on the PNR. Data identifying a plurality of selectable options of the mobile application is provided and displayed via a graphical user interface on a user device. Data identifying at least one selected option is received and the PNR code is associated with the at least one selection option. At least one order request comprising data associated with the PNR code and the at least one selected option is generated and sent to at least one vendor.

### CROSS-REFERENCE TO RELATED APPLICATIONS

This application claims the benefit of U.S. Provisional Application No. 63/087,484 filed Oct. 5, 2020, the entire disclosure of which is hereby incorporated by reference in its entirety.

### BACKGROUND

### 1. Field

This disclosure relates generally to a passenger ordering system integrated with third party vendors and, in non-limiting embodiments, systems, methods, and computer program products for placing an order in-transit via a passenger ordering system integrated with third party vendors.

### 2. Technical Considerations

Transportation reservations (e.g., airline reservations, train reservations, bus reservations, and/or the like) can be made through a computer reservation system (CRS) for a particular transportation system (e.g., airline, railway, bus line, and/or the like). CRSs are accessed to find transportation schedules and pricing and interface with a global distribution system (GDS) or a global travel distribution system. CRSs contain a database of reservations comprising passenger name records (PNRs). A PNR is a unique code which is automatically generated and stored in the CRS database upon purchasing a ticket and making a transportation reservation. A PNR contains personal information such as passenger name, passenger contact information, special service requests (SSRs) (e.g., a request for a vegetarian meal), transportation information (e.g., flight number, flight time, flight status, etc.), and ticket information. Reservation data such as the number of booked passengers and SSRs are transferred to the transportation system's operations systems, crew management, and catering systems.

### SUMMARY

Accordingly, provided are systems, devices, products, apparatus, and/or methods for using a passenger ordering system integrated with third party vendors to customize purchase options through a mobile device application.

Further non-limiting embodiments or aspects are set forth in the following numbered clauses:

Clause 1: A method for placing an order in-transit comprising: receiving, with the at least one processor, at least one input from a user, the at least one input comprising at least a passenger name record (PNR) code, wherein the PNR code is an indication of a passenger reservation associated with a record in a database of a computer reservation system; verifying, with the at least one processor, that the user is a confirmed passenger based on the PNR code; providing, with the at least one processor, data identifying a plurality of selectable options of a mobile application for the passenger ordering system; receiving, with the at least one processor, data identifying at least one selected option of the mobile application for the passenger ordering system; associating, with the at least one processor, the PNR code with the at least one selected option; generating, with the at least one processor, at least one order request, the at least one order request comprising data associated with the PNR code and the at least one selected option; and sending, with the at least one processor, the at least one order request.

Clause 2: The method of clause 1, further comprising: querying the database of the computer reservation system for data associated with the PNR code; accessing a user itinerary associated with the PNR code; generating at least one communication, wherein the at least one communication comprises data associated with the user itinerary, and wherein the at least one communication prompts the user to create an order; and sending the at least one communication to the user.

Clause 3: The method of clauses 1 or 2, further comprising: displaying data associated the at least one communication via an interactive graphical user interface (GUI), the interactive GUI comprising at least one selectable option, wherein the interactive GUI is configured to receive the at least one selection from the user, and wherein the interactive GUI is configured to be updated based on receiving the at least one selection from the user.

Clause 4: The method of clauses 1-3, further comprising: authenticating, with at least one processor, the user for access to a user profile of the mobile application for the passenger ordering system, wherein verifying that the user is a confirmed passenger based on the PNR code is based on authenticating the user to access the user profile of the mobile application for the passenger ordering system.

Clause 5: The method of clauses 1-4, further comprising: receiving at least one communication, wherein the at least one communication comprises an order acceptance or an order rejection; and updating a status of the order based on the at least communication

Clause 6: The method of clauses 1-5, further comprising: receiving data comprising a real-time status of the order; and displaying data comprising the real-time status of the order via a graphical user interface (GUI) of the mobile application for the passenger ordering system on a user device.

Clause 7: The method of clauses 1-6, further comprising: determining a change to a user itinerary; determining a change to a status of a transportation mode based on the change to the user itinerary, wherein the status of the transportation mode comprises on of on time, delayed, and cancelled; modifying an order based on the change to the status of the transportation mode, wherein modifying the order based on the change to the status of the transportation mode comprises: delaying the order, based on the status of the transportation mode being delayed; or cancelling the order, based on the status of the transportation mode being cancelled; determining a change in a location for order delivery based on the change to the user itinerary, wherein a location for order delivery comprises one of location of departure gate, in-transit, and location of arrival gate; and modifying the location for delivery based on the change to the user itinerary.

Clause 8: A system for placing an order in-transit comprising: at least one processor programmed or configured to: receive at least one input from a user, the at least one input comprising at least a passenger name record (PNR) code, wherein the PNR code is an indication of a passenger reservation associated with a record in a database of a computer reservation system; verify that the user is a confirmed passenger based on the PNR code; provide data identifying a plurality of selectable options of a mobile application for the passenger ordering system; receive data identifying at least one selected option of the mobile application for the passenger ordering system; associate the PNR code with the at least one selected option; generate at least one order request comprising data associated with the PNR code and the at least one selected option; and send the at least one order request.

Clause 9: The system of clause 8, wherein the at least one processor is further programmed or configured to: query the database of the computer reservation system for data associated with the PNR code; access a user itinerary associated with the PNR code; generate at least one communication, wherein the at least one communication comprises data associated with the user itinerary, and wherein the at least one communication prompts the user to create an order ahead of an upcoming departure; and send the at least one communication to the user.

Clause 10: The system of clauses 8 and 9, wherein the at least one processor is further programmed or configured to: display data associated the at least one communication via an interactive graphical user interface (GUI), the interactive GUI comprising at least one selectable option, wherein the interactive GUI is configured to receive the at least one selection from the user, and wherein the interactive GUI is configured to be updated based on receiving the at least one selection from the user.

Clause 11: the system of clauses 8-10, wherein the at least one processor is further programmed or configured to: authenticate the user for access to a user profile of the mobile application for the passenger ordering system, wherein verifying that the user is a confirmed passenger based on the PNR code is based on authenticating the user to access the user profile of the mobile application for the passenger ordering system.

Clause 12: The system of clauses 8-11, wherein the at least one processor is further programmed or configured to: receive at least one communication, wherein the at least one communication comprises an order acceptance or an order rejection; and update a status of the order based on the at least one communication.

Clause 13: The system of clauses 8-12, wherein the at least one processor is further programmed or configured to: receive data comprising a real-time status of the order; and display data comprising the real-time status of the order via a graphical user interface (GUI) of the mobile application for the passenger ordering system on a user device.

Clause 14: The system of clauses 8-13, wherein the at least one processor is further programmed or configured to: determine a change to a user itinerary; determine a change to a status of a transportation mode based on the change to the user itinerary, wherein the status of the transportation mode comprises on of on time, delayed, and cancelled; modify an order based on the change to the status of the transportation mode, wherein when modifying the order based on the change to the status of the transportation mode the at least one processor is further programmed or configured to: delay the order, based on the status of the transportation mode being delayed; or cancel the order, based on the status of the transportation mode being cancelled; determine a change in a location for order delivery based on the change to the user itinerary, wherein a location for order delivery comprises one of location of departure gate, in-transit, and location of arrival gate; and modify the location for delivery based on the change to the user itinerary.

Clause 15: A computer program product for placing an order in-transit, the computer program product comprising at least one non-transitory computer-readable medium including one or more instructions that, when executed by at least one processor, cause the at least one processor to: receive at least one input from a user, the at least one input comprising at least one input comprising at least a passenger name record (PNR) code, wherein the PNR code is an indication of a passenger reservation associated with a record in a database of a computer reservation system; verify that the user is a confirmed passenger based on the PNR code; provide data identifying a plurality of selectable options of a mobile application for the passenger ordering system; receive data identifying at least one selected option of the mobile application for the passenger ordering system; associate the PNR code with the at least one selected option; generate at least one order request, the at least one order request comprising data associated with the PNR code and the at least one selected option; and send the at least one order request to at least one vendor of a plurality of vendors.

Clause 16: The computer program product of clause 15, wherein the one or more instructions further cause the at least one processor to: query the database of the computer reservation system for data associated with the PNR code; accessing a user itinerary associated with the PNR code; generating at least one communication, wherein the at least one communication comprises data associated with the user itinerary, and wherein the at least one communication prompts the user to create an order; sending the at least one communication to the user; and display data associated the at least one communication via an interactive graphical user interface (GUI), the interactive GUI comprising at least one selectable option, wherein the interactive GUI is configured to receive the at least one selection from the user, and wherein the interactive GUI is configured to be updated based on receiving the at least one selection from the user.

Clause 17: The computer program product of clauses 15 and 16, wherein the one or more instructions further cause the at least one processor to: authenticate the user for access to a user profile of the mobile application for the passenger ordering system, wherein verifying that the user is a confirmed passenger based on the PNR code is based on authenticating the user to access the user profile of the mobile application for the passenger ordering system.

Clause 18: The computer program product of clauses 15-17, wherein the one or more instructions further cause the at least one processor to: receive at least one communication, wherein the at least one communication comprises an order acceptance or an order rejection; and update a status of the order based on the at least one communication.

Clause 19: The computer program product of clauses 15-18, wherein the one or more instructions further cause the at least one processor to: receive data comprising a real-time status of the order; and display data comprising the real-time status of the order via a graphical user interface (GUI) of the mobile application for the passenger ordering system on a user device.

Clause 20: The computer program product of clauses 15-19, wherein the one or more instructions further cause the at least one processor to: determine a change to a user itinerary; determine a change to a status of a transportation mode based on the change to the user itinerary, wherein the status of the transportation mode comprises on of on time, delayed, and cancelled; modify an order based on the change to the status of the transportation mode, wherein when modifying the order based on the change to the status of the transportation mode the one or more instructions further cause the at least one processor to: delay the order, based on the status of the transportation mode being delayed; or cancel the order, based on the status of the transportation mode being cancelled; determine a change in a location for order delivery based on the change to the user itinerary, wherein a location for order delivery comprises one of location of departure gate, in-transit, and location of arrival gate; and modify the location for delivery based on the change to the user itinerary.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is an exemplary diagram of non-limiting embodiments of an environment in which systems, devices, products, apparatus, and/or methods, described herein, may be implemented according to the principles of the present disclosure;

FIG. 2 is a diagram of non-limiting embodiments or components of one or more systems or one or more devices of FIG. 1;

FIG. 3 is an exemplary flowchart of a non-limiting embodiment or aspect of a process for placing an order in-transit;

FIG. 4 is an exemplary flowchart of an implementation of a non-limiting embodiment or aspect of the process shown in FIG. 3; and

FIGS. 5A-5H are exemplary diagrams of non-limiting embodiments or aspects of a graphical user interface (GUI) displayed during a process for placing an order in-transit options.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature.

Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “computing device” may refer to one or more electronic devices configured to process data. A computing device may include the necessary components to receive, process, and output data, such as a processor, a display, a memory, an input device, a network interface, and/or the like. A computing device may be a mobile device, such as a cellular phone (e.g., a smartphone), a portable computer, a wearable device (e.g., watches, glasses, lenses, clothing, and/or the like), a personal digital assistant (PDA), and/or other like devices. A computing device may also include a desktop computer or other form of non-mobile computer.

As used herein, the term “user” may refer to an individual consumer, purchaser, and/or subscriber of the mobile application for the passenger ordering system.

As used herein, the term “vendor” may refer to an entity that provides a plurality of food items and non-food items. The term “vendor” or “vendor system” may also refer to one or more computer systems operated by or on behalf of a vendor, such as a server computer executing one or more software applications.

Traditional food service systems on transportation modes involve catering systems which prepare and package meals, load the meals onto the transportation modes, and deliver the meals to passengers. Transportation carriers may be low cost carriers (e.g., no meal included in ticket price) or full-service carriers (e.g., catered meal included in ticket price). Low cost carriers may offer a small selection of snacks and/or beverages available in-transit, however, the selection and availability of snacks and/or beverages is limited to what is loaded onto the transportation mode prior to departure. Full service carriers typically offer a meal selection based on the time of day of the transportation (e.g., breakfast in the morning, lunch in the afternoon, and dinner in the evening). The selection and availability of meals is limited to what is provided by a catering system and loaded onto the transportation mode prior to departure. Traditional transportation catering systems typically offer passengers an option for selecting a general category of food. For example, a traditional airline catering system may offer a passenger a choice between a vegetarian or a non-vegetarian in-flight meal option but the passenger is given no other details about what exactly they will be served. As such, passengers are unable to customize their food options and are bound by the selections prepared by a catering service and the quantity that is pre-loaded onto the transportation mode.

Additionally, while most transportation systems do allow passengers to bring food and beverage items onboard for travel, purchasing food items ahead of departure may be time consuming and carrying additional items onboard may be difficult. Unexpected changes in travel (e.g., delay, cancellation, missing a connection, etc.) may disrupt a traveler's plans and cause them to lose time they had planned to order and eat a meal. Further, travelers may wish to eat upon arrival at their destination but may be exhausted from travel and not wish to wait in lines.

Ordering food in-transit typically requires passengers to plan ahead and wait in long lines. Even with careful planning, unexpected delays, cancellations, and changes to departure and/or arrival locations (e.g., departure terminals, arrival terminal) may disrupt a passenger's schedule. Further, while full-service carriers offer in-transit meals prepared by catering companies associated with the transportation service, passengers are unable to customize meal options or select items for purchase outside of the catering company's offerings. As such, there is a need for a passenger ordering system integrated with third party vendors that will allow passengers to customize orders, select delivery options (e.g., departure gate delivery, in-transit delivery, arrival gate delivery), and automatically modify order details based on changes to a user itinerary.

Non-limiting embodiments or aspects of the present disclosure are directed to methods, systems, products, and/or apparatus for creating an order in-transit via a passenger ordering system. In some non-limiting embodiments or aspects, a passenger ordering system may include at least one processor programmed or configured to receive at least one input from a user, the at least one input comprising at least a passenger name record (PNR) code, wherein the PNR code is an indication of a passenger reservation associated with a record in a database of a computer reservation system; provide data identifying a plurality of selectable options of a mobile application for the passenger ordering system; receive data identifying at least one selected option of the mobile application for the passenger ordering system; associate the PNR code with the at least one selected option; generate at least one order request, the at least one order request comprising data associated with the PNR code and the at least one selected option; and send the at least one order request. In some non-limiting embodiments or aspects, the at least one processor is further programmed or configured to query a database of a computer reservation system for data associated with the PNR code; access a user itinerary associated with the PNR code; generate at least one communication wherein the at least one communication comprises data associated with the user itinerary, and wherein the at least one communication prompts a user to create an order; and send the at least one communication to a user. In some non-limiting embodiments or aspects, the at least one processor is further programmed or configured to display the data associated with the at least one selected option of the mobile application for the passenger ordering system via a graphical user interface (GUI) of a mobile application on a user device. In some non-limiting embodiments or aspects, the GUI may be an interactive GUI comprising at least one input box and/or at least one selectable option and configured to receive at least one input and/or at least one selected option from a user. In some non-limiting embodiments or aspects, the GUI may be configured to be updated based on an input from a user and/or a selection made by a user. In some non-limiting embodiments or aspects, the at least one processor may be further programmed or configured to determine whether the user is authorized to access the user profile of the mobile application for the passenger ordering system based on authenticating the user for access to a user profile of a mobile application for the passenger ordering system, wherein verifying that a user is a confirmed passenger based on the PNR code is based on authenticating a user to access the user profile of the mobile application for the passenger ordering system.

In some non-limiting embodiments or aspects, the at least one processor may be further programmed or configured to receive at least one communication, wherein the at least one communication comprises an order acceptance or an order rejection; and update a status of the order based on the at least one communication. In some non-limiting embodiments or aspects, the at least one processor may be further programmed or configured to receive data comprising a real-time status of the order; and display data comprising the real-time status of the order via a GUI of the mobile application for the passenger ordering system on the user device.

In some non-limiting embodiments or aspects, the at least one processor may be further programmed or configured to determine a change in a user itinerary; and determine a change to a status of a transportation mode based on the change to the user itinerary, wherein the status of the transportation mode comprises one of on time, delayed, and cancelled. In some non-limiting embodiments or aspects, the at least one processor may be further configured to modify an order based on a change to the status of a transportation mode. In some non-limiting embodiments or aspects, when modifying an order based on a change to a status of a transportation mode, the at least one processor may be further programmed or configured to delay the order, based on the status of the transportation mode being delayed; or cancel the order, based on the status of the transportation mode being cancelled. In some non-limiting embodiments or aspects, the at least one processor may be further programmed or configured to determine a change in a location for order delivery based on a change to a user itinerary, wherein a location for order delivery comprises one of location of departure gate, in-transit, and location of arrival gate. In some non-limiting embodiments or aspects, the at least one processor may be further programmed or configured to modify a location for delivery based on a change to a user itinerary.

In this way, non-limiting embodiments or aspects of the present disclosure provide a new way of placing an order in-transit allowing a user to customize purchase options and delivery options (departure location delivery, in-transit delivery, and/or arrival location delivery) via a passenger ordering system integrated with third party vendors. In some non-limiting embodiments or aspects, a user's passenger name record (PNR) code may be associated with an order placed by the user and/or individual selections made by the user. By associating the PNR code to a user's order and/or individual selections made by the user, the passenger ordering system may automatically receive real-time updates about changes in a user's user itinerary (e.g., transportation mode delayed or cancelled, location of departure gate changed, and/or location of arrival gate changed) and may automatically modify the order (e.g., cancel or delay the order) and/or modify the delivery location (e.g., change the delivery location from the location of the original gate to the location of the changed gate).

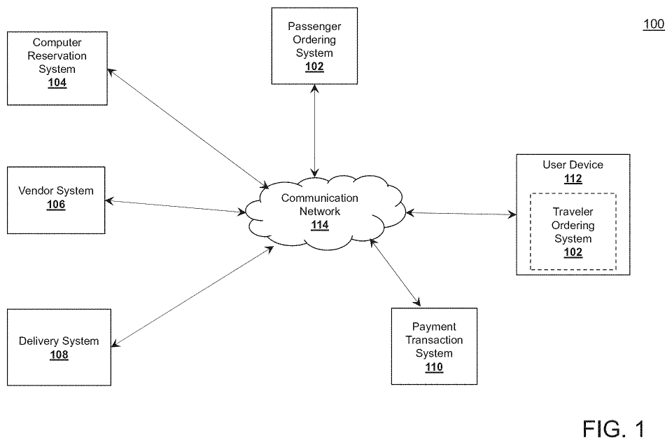

Referring now to FIG. 1, shown is an exemplary diagram of a non-limiting embodiment or aspect of an environment 100 in which systems, devices, products, apparatus, and/or methods, described herein, may be implemented according to the principles of the present disclosure. As shown in FIG. 1, environment 100 may include passenger ordering system 102, computer reservation system 104, vendor system 106, delivery system 108, payment transaction system 110, user device 112, and communication network 114. In some non-limiting embodiments or aspects, passenger ordering system 102, computer reservation system 104, vendor system 106, delivery system 108, payment transaction system 110, and/or user device 112, may interconnect (e.g., establish a connection to communicate) via wired connections, wireless connections, or a combinations or wired and wireless connections.

In some non-limiting embodiments or aspects, passenger ordering system 102 may include one or more devices capable of being in communication with computer reservation system 104, vendor system 106, delivery system 108, payment transaction system 110, and/or user device 112 via communication network 114. For example, passenger ordering system 102 may include a computing device, such as a computer, a server, a group of servers, and/or other like devices. In some non-limiting embodiments or aspects, passenger ordering system 102 may be associated with a passenger ordering service provider as described herein. For example, passenger ordering system 102 may be operated by a passenger ordering service provider. In some non-limiting embodiments or aspects, passenger ordering system 102 may associated with an application on a mobile device as described herein.

In some non-limiting embodiments or aspects, computer reservation system 104 may include one or more devices capable of being in communication with passenger ordering system 102, vendor system 106, delivery system 108, payment transaction system 110, and/or user device 112 via communication network 114. For example, computer reservation system 104 may include a computing device, such as a computer, a server, a group of servers, and/or other like devices. In some non-limiting embodiments or aspects, computer reservation system 104 may be associated with an airline, a railway, and/or a bus line as described herein. For example, computer reservation system 104 may be operated by an airline, a railway, or a bus line. In some non-limiting embodiments or aspects, computer reservation system 104 may include a database of a transportation reservation booking system (e.g., database of an airline reservation booking system, a database of a railway reservation booking system, a database of a bus line reservation booking system, and/or the like) storing data.

In some non-limiting embodiments or aspects, vendor system 106 includes one or more devices capable of being in communication with passenger ordering system 102, computer reservation system 104, delivery system 108, payment transaction system 110, and/or user device 112 via communication network 114. For example, vendor system 106 may include a computing device, such as a computer, a server, a group of servers, and/or other like devices. In some non-limiting embodiments or aspects, vendor system 106 may be associated with a vendor as described herein. For example, vendor system 106 may be operated by a vendor. In some non-limiting embodiments or aspects, vendor system 106 may include a database of a vendor system storing data.

In some non-limiting embodiments or aspects, delivery system 108 includes one or more devices capable of being in communication with passenger ordering system 102, computer reservation system 104, vendor system 106, payment transaction system 110, and/or user device 112 via communication network 114. For example, delivery system 108 may include a computing device, such as a computer, a server, a group of servers, and/or other like devices. In some non-limiting embodiments or aspects, delivery system 108 may include features such as route optimization and/or a machine learning component. For example, delivery system 108 may use a machine learning component to optimize delivery routes. In some non-limiting embodiments or aspects, delivery system 108 may be associated with a delivery service and/or a vendor as described herein. For example, delivery system 108 may be operated by a delivery service and/or a vendor. In some non-limiting embodiments or aspects, delivery system 108 may include a database of a delivery system storing data.

In some non-limiting embodiments or aspects, payment transaction system 110 may include one or more devices capable of being in communication with passenger ordering system 102, computer reservation system 104, vendor system 106, delivery system 108, and/or user device 112 via communication network 114. For example, payment transaction system 110 may include a computing device, such as a computer, a server, a group of servers, and/or other like devices. Payment transaction system 110 may be associated with an entity that processes transactions. Payment transaction system 110 may be configured to generate payment requests, receive payment authentications, and/or process payment transactions.

In some non-limiting embodiments or aspects, user device 112 includes one or more devices capable of being in communication with passenger ordering system 102, computer reservation system 104, vendor system 106, delivery system 108, and/or payment transaction system 110 via communication network 114. For example, user device 112 may include a computing device, such as a computer (e.g., a desktop, a laptop, etc.) or a mobile device (e.g., a smart phone, a tablet, etc.). In some non-limiting embodiments, user device 112 may be capable of reading (e.g., scanning) a barcode, such as a quick response (QR) code. In some non-limiting embodiments, user device 112 may be configured to transmit and/or receive data to and/or from another device or system (e.g., passenger ordering system 102, computer reservation system 104, vendor system 106, delivery system 108, and/or payment transaction system 110) via a short-range wireless communication connection (e.g., an NFC communication connection, an RFID communication connection, a Bluetooth® communication connection, and/or the like). In some non-limiting embodiments, user device 112 may be configured to transmit and/or receive data via radio frequency identification (RFID). For example, user device 112 may include an RFID reader. In some non-limiting, user device 112 may be associated with a user (e.g., an individual operating a device). In some non-limiting embodiments or aspects, one or more software (e.g., mobile) applications may be associated with (e.g., installed and/or executed on) user device 112 (e.g., an application stored on user device 112, such as a mobile device application, a native application for a mobile device, a mobile cloud application for a mobile device, etc.).

In some non-limiting embodiments, communication network 114 may include one or more wired and/or wireless networks. For example, communication network 114 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, a short range wireless communication network (e.g., a Bluetooth network, a near field communication (NFC) network, etc.) and/or the like, and/or a combination of these or other types of networks.

With continued reference to FIG. 1, in some non-limiting embodiments or aspects, passenger ordering system 102 may receive at least one input from a user as described herein. The at least one input may comprise a PNR code. The PNR code may be an indication of a passenger reservation associated with a record in a database of computer reservation system 104. For example, passenger ordering system 102 may receive at least one input from a user comprising a PNR code. Additionally or alternatively, passenger ordering system 102 may verify that the user is a confirmed passenger as described herein. Verification that the user is a confirmed passenger may be based on the PNR code. Additionally or alternatively, passenger ordering system 102 may provide data identifying a plurality of selectable options of a mobile application for the passenger ordering system as described herein. For example, passenger ordering system 102 may display data identifying selectable options available to the user of the mobile application for the passenger ordering system via a GUI on user device 112. The plurality of selectable options comprising at least: an option to select to order a standard meal (e.g., standard meal included with purchase of a ticket from a full-service carrier and offered by a catering company associated with the transportation carrier), an option to select to create an order, a plurality of categories, a plurality of sub-categories, an option to select a location of delivery (e.g., location of departure gate, in-transit, location of arrival gate), an option to select a payment method. Additionally or alternatively, passenger ordering system 102 may receive data identifying at least one selectable option of the mobile application for the passenger ordering system as described herein. For example, passenger ordering system 102 may receive at least one selection made by the user. Additionally or alternatively, passenger ordering system 102 may associate the PNR code with at least one selectable option as described herein. For example, passenger ordering system 102 may associate the PNR code with the at least one selection made by the user.

Additionally or alternatively, passenger ordering system 102 may generate at least one order request as described herein. The at least one order request may comprise data associated with the PNR code and/or the at least one selected option. For example, passenger ordering system 102 may generate at least one order request comprising data associated with the PNR code and the at least one selection made by the user. Additionally or alternatively, passenger ordering system 102 may generate a unique order identification number. The unique order identification number may be automatically generated upon generating the at least one order request. For example, upon receiving at least one selection from a user, passenger ordering system 102 may automatically generate a unique identification number. The unique order identification number may be a combination of numbers and/or letters. In some non-limiting embodiments or aspects, the unique order identification number may be the PNR code. In some non-limiting embodiments or aspects, the unique order identification number may be associated with the PNR code. Additionally or alternatively, passenger ordering system 102 may associate the unique order identification number with at the at least one option selected by the user as described herein. For example, passenger ordering system 102 may generate a unique order identification number and associate the unique order identification number with an order and/or each item of an order (e.g., each item selected by the user for purchase from at least one vendor of a plurality of vendors). Additionally or alternatively, passenger ordering system 102 may send the at least one order request as described herein. For example, passenger ordering system 102 may send the at least one order request to vendor system 106.

In some non-limiting embodiments or aspects, the at least one order request may contain data identifying a user's selection of a standard meal option offered by a catering company associated with a transportation carrier. In some non-limiting embodiments or aspects, the at least one order request may contain data alerting a catering company associated with a transportation carrier that a user has selected not to receive a standard meal provided by the catering company, causing the catering company to prepare one less standard meal.

Additionally or alternatively, passenger ordering system 102 may query a database of computer reservation system 104 for a PNR code as described herein. For example, passenger ordering system 102 may query a database of computer reservation system 104 for a PNR code input by a user. Additionally or alternatively, passenger ordering system 102 may access a user itinerary associated with a PNR code as described herein. For example, passenger ordering system 102 may access a user itinerary associated with a PNR code and stored in a database of computer reservation system 104. The user itinerary may comprise data such as, but not limited to, a PNR code, PNR code details, passenger information (e.g., passenger name, passenger date of birth, etc.), passenger travel information (e.g., location of departure, location of arrival, departure date, arrival date etc.), transportation mode information (e.g., carrier of the transportation mode, departure time, departure gate, arrival time, arrival gate, etc.), a status of the transportation mode (e.g., on time, delayed, cancelled), and/or the like. Additionally or alternatively, passenger ordering system 102 may generate at least one communication as described herein. The at least one communication may be associated with the user itinerary. The at least one communication may prompt the user to create an order. The at least one communication may be a reminder message (e.g., reminder to place an order ahead of departure), an alert notification, and/or personalized message (e.g., personalizing a message based on data from a user profile of the mobile application for the passenger ordering system, data associated with the PNR code, and/or data associated with the user itinerary). In some non-limiting embodiments or aspects, the at least one first communication may be sent twenty-four (24) hours or less in advance of the transportation departure (e.g., within three (3) hours of transportation departure).

Additionally or alternatively, passenger ordering system 102 may send the at least one communication to the user as described herein. For example, passenger ordering system 102 send the at least one communication to user device 112.

Additionally or alternatively, passenger ordering system 102 may display data associated with the at least one communication via an interactive GUI as described herein. For example, passenger ordering system 102 may display data associated with the at least one communication on user device 112. The interactive GUI may comprise at least one selectable option and/or at least one input option. The interactive GUI may be configured to receive at least one selection from the user and/or at least one input from the user. The interactive GUI may be configured to be updated based on receiving the at least one selection from the user and/or the at least one input from the user.

Additionally or alternatively, passenger ordering system 102 may authenticate the user for access to a user profile of the mobile application for the passenger ordering system as described herein. For example, passenger ordering system 102 may authenticate a user, based on receiving an input from the user of at least one user identifying feature or login credential. Verification that the user is a confirmed passenger based on the PNR code may be based on authenticating the user to access the user profile of the mobile application for the passenger ordering system. In some non-limiting embodiments or aspects, passenger ordering system 102 may receive data associated with a user identification from a user via user device 112 (e.g., a software application stored on user device 112) during a login process. In some non-limiting embodiments or aspects, passenger ordering system 102 may display an interactive GUI on user device 112. In some non-limiting embodiments or aspects, an interactive GUI may be configured to receive a user input as part of a login process. For example, user device 112 may display an interactive GUI configured to receive at least one input from a user. The user input may include login credentials comprising data associated with user identification (e.g., data identifying a user name, a user password, a user personal identification number (PIN), and/or the like). In some non-limiting embodiments, the login credential may include a biometric measurement of a user (e.g., a fingerprint, an iris scan, an image of a body part of a user, etc.).

Additionally or alternatively, passenger ordering system 102 may receive at least one communication as described herein. For example, passenger ordering system 102 may receive at least one communication from vendor system 106. The at least one communication may comprise an order acceptance or an order rejection. The at least one communication may be a message, an alert, and/or an order status update. Additionally or alternatively, passenger ordering system 102 may update a status of the order (e.g., accepted, rejected, delayed, cancelled, processing, en route, delivered/complete, etc.) based on the at least one communication. For example, if the at least one communication comprises an order acceptance, passenger ordering system 102 may update a status of the order to accepted. A status of the order may be updated by passenger ordering system 102, computer reservation system 104, vendor system 106, delivery system 108, payment transaction system 110, and/or user device 112. In some non-limiting embodiments or aspects, passenger ordering system 102 may receive real-time updates about changes in a user's user itinerary from computer reservation system 104. For example, passenger ordering system 102 may receive a data identifying a change in a user itinerary from computer reservation system 104.

Additionally or alternatively, passenger ordering system 102 may determine a change to a user itinerary as described herein. For example, passenger ordering system 102 may determine a change to the user itinerary by accessing the user itinerary. Additionally or alternatively, passenger ordering system 102 may determine a change to a status of a transportation mode based on a change to the user itinerary as described herein. A status of the transportation mode may be one of on time, delayed, and cancelled. For example, passenger ordering system 102 may determine if a status of the transportation mode has been updated to delayed or cancelled on the user itinerary. Additionally or alternatively, passenger ordering system 102 may modify an order based on a change to a status of a transportation mode as described herein. Additionally or alternatively, modifying an order based on a change to a status of a transportation mode may comprise delaying the order, based on the status of the transportation mode being delayed; or cancelling the order, based on the status of the transportation mode being cancelled as described herein. For example, passenger ordering system 102 may cancel or delay an order based on the status of the transportation mode being cancelled or delayed, respectively. In some non-limiting embodiments or aspects, if the status of the transportation mode is delayed, passenger ordering system 102 may automatically generate and send at least one communication to vendor system 106, delivery system 108, and/or user device 112. The at least one communication may comprise a message to cancel or delay the order. Additionally or alternatively, passenger ordering system 102 may determine a change in a location for order delivery (e.g., change in location of departure gate for an order selected to be delivered at the departure gate, change in location of arrival gate for an order selected to be delivered at the arrival gate) as described herein. A location for order delivery may comprise one of location of departure gate, in-transit, and location of arrival gate. For example, passenger ordering system 102 may determine a change in a location for order delivery based on a change to the user itinerary. Additionally or alternatively, passenger ordering system 102 may modify a location for order delivery based on a change to the user itinerary. For example, based on a change in location for delivery, passenger ordering system 102 may modify the location for order delivery.

Additionally or alternatively, passenger ordering system 102, computer reservation system 104, vendor system 106, delivery system 108, and/or user device 112 may update a status of the order as described herein. For example, a status of the order made be updated based on an acceptance/rejection of the order by vendor system 106, processing of the order by vendor system 106, preparation of the order by vendor system 106, pick-up of the order by delivery system 108, transporting the order by delivery system 108, delivery the order by delivery system 108, a change to a user itinerary by passenger ordering system 102, a cancellation of the order by passenger ordering system 102, vendor system 106, and/or user device 112, an acceptance of the order by a user by user device 112. In some non-limiting embodiments or aspects, a QR code may be attached (e.g., stuck on, taped on, stapled to, etc.) a packaging of the order and/or each item of the order. The QR code may comprise a PNR code and/or a unique order identification number associated with an order and/or individuals items of the order. The QR code may be scanned by vendor system 106, delivery system 108, and/or user device 112, causing a status of the order to be updated.

Additionally or alternatively, upon receiving data identifying that an order has been received by the user, passenger ordering system 102 may provide data identifying a selection for a user to participate in an order review and/or rate their experience using the mobile application for the passenger ordering system. In some non-limiting embodiments or aspects, passenger ordering system 102 may sense a WiFi connection or internet geoforce (a location-based service to trigger a pre-programmed action when a mobile device enters or exits a virtual boundary set up around a geographical location) and provide data identifying a selection for a user to participate in an order review and/or rate their experience using the mobile application for the passenger ordering system. For example, for a user who selected to receive an ordering delivery in-transit (on board a transportation mode), passenger ordering system 102 may sense a WiFi connection and provide data identifying a selection for the user to participate in an order review and/or rate their experience using the mobile application for the passenger ordering system via an interactive GUI displayed on user device 112. In some non-limiting embodiments or aspects, ratings data and user experience data received from the user may be stored in a database of passenger ordering system 102 and may be sorted and/or analyzed (e.g., using at least one machine learning process).

The number and arrangement of systems, devices, and networks shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or a single device, or a single system or a single device shown in FIG. 1 may be implemented as multiple, distributed systems or devices. Additionally, or alternatively, a set of systems or a set of devices (e.g., one or more systems, one or more devices, etc.) of environment 100 may perform one or more functions described as being performed by another set of systems or another set of devices of environment 100.

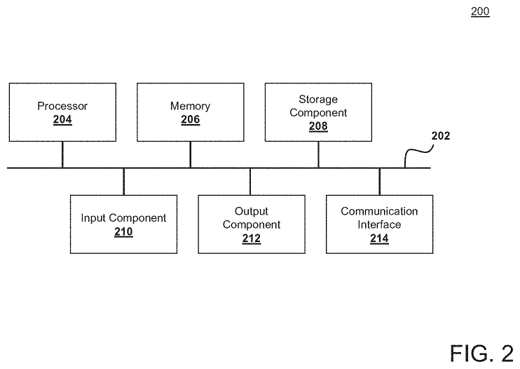

Referring now to FIG. 2, FIG. 2 is a diagram of example components of a device 200. Device 200 may correspond to one or more devices of computer reservation system 104, vendor system 106, delivery system 108, payment transaction system 110, user device 112, and/or passenger ordering system 102. In some non-limiting embodiments, computer reservation system 104, vendor system 106, delivery system 108, payment transaction system 110, user device 112, and/or passenger ordering system 102 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

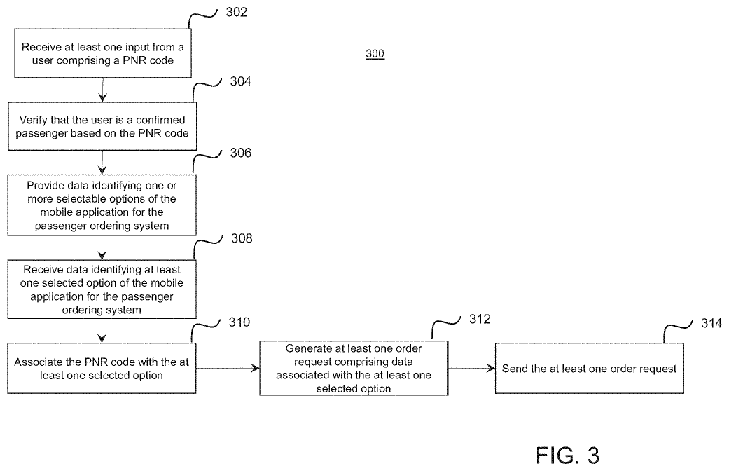

Referring now to FIG. 3, shown is a flowchart of a non-limiting embodiment or aspect of a process for placing an order in-transit using a mobile application for a passenger ordering system. The steps shown in FIG. 3 are for example purposes only. It will be appreciated that additional, fewer, different, and/or a different order of steps may be used in non-limiting embodiments. In some non-limiting embodiments or aspects, one or more of the steps of process 300 may be performed (e.g., completely, partially, etc.) by passenger ordering system 102 (e.g., one or more devices of passenger ordering system 102). In some non-limiting embodiments or aspects, one or more of the steps of process 300 may be performed (e.g., completely, partially, etc.) by another device or group of devices separate from or including passenger ordering system 102, such as computer reservation system 104 (e.g., one or more devices of computer reservation system 104), vendor system 106 (e.g., one or more devices of vendor system 106), delivery system 108 (e.g., one or more devices of runner/deliver system 108), payment transaction system 110 (e.g., one or more devices of payment transaction system 110), and/or user device 112.

Aspects (e.g., one or more of the steps of process 300) of non-limiting embodiments herein may be performed with regard to a software application, such as a mobile application, with a client-side component stored on user device 112 that is associated with a server-side component of passenger ordering system 102.

As shown in FIG. 3, at step 302, process 300 may include receiving at least one input from a user comprising a PNR code. For example, passenger ordering system 102 may receive an input from the user comprising a PNR code. In some non-limiting embodiments or aspects, the PNR code may be an indication of a passenger reservation associate with a record in a database of computer reservation system 104. In some non-limiting embodiments or aspects, passenger ordering system 102 may display an interactive GUI on user device 112. In some non-limiting embodiments or aspects, the interactive GUI may be configured to receive a user input. The interactive GUI may be configured to be updated based on the user input. In some non-limiting embodiments or aspects, the PNR code may be automatically generated and stored in a database of computer reservation system 104 when the user purchases a travel ticket (e.g., airline ticket, railway ticket, bus ticket, and/or the like) for a transportation mode. The PNR code may comprise a unique combination of numbers and/or letters and may be unique to the user. The PNR code may include details such as, but not limited to, passenger name, passenger special service request (SSR) (e.g., a message communicating the user's preferences, special service needed by the user, etc.), transportation information (e.g., transportation mode, transportation company, departure date, arrival date, departure time, arrival time, departure gate, arrival gate, etc.) and/or transportation mode status (e.g., on time, delayed, or cancelled). The PNR code may be used to confirm that the user has purchased a travel ticket and/or that the user is a confirmed passenger of a transportation mode.

As shown in FIG. 3, at step 304, process 300 may include verifying that the user is a confirmed passenger based on the PNR code. For example, passenger ordering system 102 may access a database of computer reservation system 104 to verify that the user is a confirmed passenger based on the PNR code input by the user.

As shown in FIG. 3, at step 306, process 300 may include providing data identifying one or more selectable options of the mobile application for the passenger ordering system. For example, passenger ordering system 102 may provide data identifying the one or more options of a mobile application for the passenger ordering system to user device 112. In some non-limiting embodiments or aspects, data identifying one or more selectable options of the mobile application for the passenger ordering system may be generated, updated, and/or modified based on data received from computer reservation system 104, vendor system 106, delivery system 108, payment transaction system 110, and/or user device 112. In some non-limiting embodiments or aspects, passenger ordering system 102 may display an interactive GUI comprising at least one selectable option on user device 112. In some non-limiting embodiments or aspects, the interactive GUI may be configured to receive an input from the user. In some non-limiting embodiments or aspects, the interactive GUI may be configured to be updated based on a user selection.

In some non-limiting embodiments or aspects, passenger ordering system 102 may provide data identifying an option to select a standard meal provided by a catering company associated with a transportation mode. For example, passenger ordering system 102 may display an interactive GUI comprising a selectable option to select standard meal provided by a catering company associated with the transportation mode on user device 112. In some non-limiting embodiments or aspects, a standard meal provided by a catering company associated with a transportation mode may be included in the purchase price of a travel ticket (e.g., full-service carrier).

In some non-limiting embodiments or aspects, passenger ordering system 102 may provide data identifying an option to create a new order, view upcoming orders, and/or view order history. For example, passenger ordering system 102 may display an interactive GUI comprising selectable options to create a new order, view upcoming orders, and/or view order history on user device 112.

In some non-limiting embodiments or aspects, passenger ordering system 102 may provide data identifying an option to select at least one category from a plurality of categories. The plurality of categories may comprise a plurality of vendors. For example, passenger ordering system 102 may display an interactive GUI comprising selectable options to select one or more vendors on user device 112. In some non-limiting embodiments or aspects, passenger ordering system 102 may provide data identifying at least one sub-category of a plurality of sub-categories. The plurality of sub-categories may comprise a plurality of items (e.g., food items and non-food items) available for purchase from at least one vendor of the plurality of vendors. For example, passenger ordering system 102 may display an interactive GUI comprising selectable options to select at least one item of the plurality of items on user device 112. In some non-limiting embodiments or aspects, passenger ordering system 102 may provide a selectable option identifying data for each category of the plurality of categories and each item of the plurality of items. For example, an interactive GUI may display selectable options for each category of the plurality of categories and each items of the plurality of items. In some non-limiting embodiments or aspects, passenger ordering system 102 may provide a selectable option identifying a set of the plurality of categories (e.g., Restaurants, Clothing Stores, Electronics Stores, Convenience Stores, etc.) and/or a set of the plurality of items (e.g., Salads, Fast Food, Bakery Items, Desserts, Beverages, Electronics, Reading Materials, etc.).

In some non-limiting embodiments or aspects, passenger ordering system 102 may provide data identifying an option to select at least one payment method (e.g., credit card, debit card, gift card, and/or the like). For example, passenger ordering system 102 may display an interactive GUI comprising selectable options to select at least one payment method methods on user device 112. In some non-limiting embodiments or aspects, passenger ordering system 102 may provide data identifying an option to add at least one payment method.

As shown in FIG. 3, at step 308, process 300 may include receiving data identifying at least one selected option of the mobile application for the passenger ordering system. For example, passenger ordering system 102 may receive data identifying a selected option of the mobile application for the passenger ordering system.

In some non-limiting embodiments or aspects, passenger ordering system 102 may receive a request to generate at least one order request based on a selection of at least one selectable option. For example, at least one selectable option may be displayed on user device 112 via an interactive GUI, the user may select the at least one selectable option, and based on the selection from the user, the interactive GUI may be updated to display another at least one selectable option on user device 112. The user may select an option to create an order, based on the user's selection to create an order, the interactive GUI may display an option to select a category from a plurality of categories. The user may select a category from the plurality of categories, based on the user's category selection, the interactive GUI may display a sub-category of the at least one category of the plurality of categories. In some non-limiting embodiments or aspects, passenger ordering system 102 may receive data identifying a selection of a plurality of categories and/or a plurality of sub-categories. For example, passenger ordering system 102 may receive data identifying a selection of one or more items of the plurality of items from one or more vendors of the plurality of vendors.

In some non-limiting embodiments or aspects, passenger ordering system 102 may receive data identifying a selection to select a standard meal provided by a catering company associated with a transportation mode.

In some non-limiting embodiments or aspects, passenger ordering system 102 may receive data identifying a selection of at least one payment method. For example, passenger ordering system 102 may receive data identifying a user's selection of a payment method based on the user's input to an interactive GUI via user device 112.

As shown in FIG. 3, at step 310, process 300 may include associating the PNR code with the at least one selected option. For example, passenger ordering system 102 may associate the PNR code with the at least one selected option received from the user. In some non-limiting embodiments or aspects, passenger ordering system 102 may associate the PNR code with each item of the plurality of items selected by the user. For example, passenger ordering system 102 may associate the PNR code with each item of the plurality of items selected by the user as part of the user's order.

As shown in FIG. 3, at step 312, process 300 may include generating at least one order request comprising data associated with the at least one selected option. For example, passenger ordering system 102 may generate at least one order request based on a user's input to an interactive GUI via user device 112. In some non-limiting embodiments or aspects, the at least one order request may comprise data associated with the PNR code and the at least one selected option. In some non-limiting embodiments or aspects, the PNR code may be associated with one or more selections made by the user. For example, passenger ordering system 102 may associate the PNR code with each item selected by the user for purchase.

As shown in FIG. 3, at step 314, process 300 may include sending the at least one order request. For example, passenger ordering system 102 may send the at least one order request to vendor system 106. In response to receiving the at least one order request, vendor system 106 may generate and send at least one communication comprising an order acceptance message and/or an order rejection message. For example, the at least one order request may be accepted or rejected by each vendor of the plurality of vendors from which the user has selected at least one item of the plurality of items for purchase. In some non-limiting embodiments or aspects, an order acceptance may comprise at least the unique order identification number and/or the PNR code. In some non-limiting embodiments or aspects, upon receiving an order acceptance from the at least one vendor, the order may be automatically processed and/or the order status may be updated. For example, upon receiving an order acceptance from the at least one vendor, the order may be processed by vendor system 106, and/or delivery system 108 and/or the order status may be updated by passenger ordering system 102, vendor system 106, and/or delivery system 108. In some non-limiting embodiments or aspects, passenger ordering system 102 may receive an order rejection from vendor system 106 In some non-limiting embodiments or aspects, upon receiving an order rejection from vendor system 106, a part of the order (e.g., one or more items of a plurality of items making up the order) or the entire order may be cancelled.

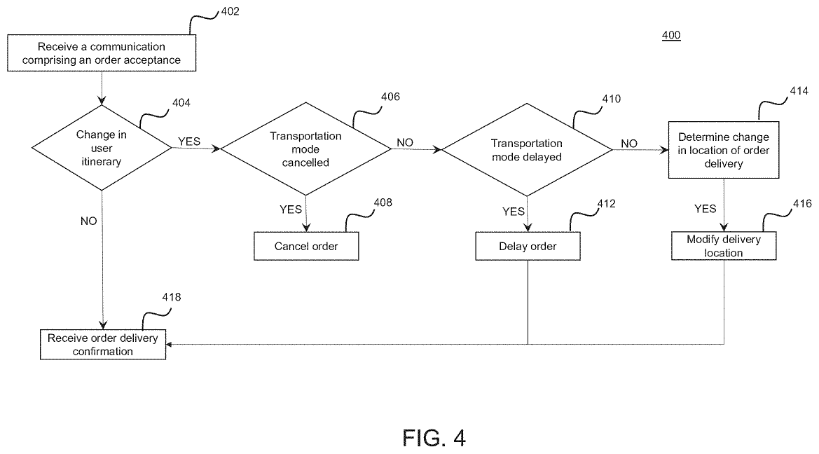

Referring now to FIG. 4, shown in an exemplary flowchart of an implementation of a non-limiting embodiment or aspect of the process shown in FIG. 3. The steps shown in FIG. 4 are for example purposes only. It will be appreciated that additional, fewer, different, and/or a different order of steps may be used in non-limiting embodiments. In some non-limiting embodiments or aspects, one or more of the steps of process 400 may be performed (e.g., completely, partially, etc.) by passenger ordering system 102 (e.g., one or more devices of passenger ordering system 102). In some non-limiting embodiments or aspects, one or more of the steps of process 400 may be performed (e.g., completely, partially, etc.) by another device or group of devices separate from or including passenger ordering system 102, such as computer reservation system 104 (e.g., one or more devices of computer reservation system 104), vendor system 106 (e.g., one or more devices of vendor system 106), delivery system 108 (e.g., one or more devices of runner/deliver system 108), payment transaction system 110 (e.g., one or more devices of payment transaction system 110), and/or user device 112.

As shown in FIG. 4, at step 402, process 400 may include receiving a communication comprising an order acceptance. For example, passenger ordering system 102 may receive a communication comprising an order acceptance.

As shown in FIG. 4, at step 404, process 400 may include determining whether the user itinerary has changed (e.g., change in a status of a transportation mode, change in location of departure, change in location of arrival). In some non-limiting embodiments or aspects, passenger ordering system 102 may determine whether a user itinerary has changed. For example, if passenger ordering system 102 determines that the user itinerary has not changed, process 400 may continue to step 418. If passenger ordering system 102 determines that the user itinerary has changed, process 400 may continue to step 406. In some non-limiting embodiments or aspects, passenger ordering system 102 may continuously access a user itinerary to determine if a change has been made to the user itinerary. In some non-limiting embodiments or aspects, passenger ordering system 102 may receive at least one communication from computer reservation system 104, the at least one communication comprising data associated with the change to the user itinerary.

As shown in FIG. 4, at step 406, process 400 may include determining whether a status of the transportation is cancelled. In some non-limiting embodiments or aspects, passenger ordering system 102 may determine a status of a transportation mode is cancelled. For example, if passenger ordering system 102 determines a status of the transportation mode is cancelled, process 400 may continue to step 408. If passenger ordering system 102 determines that a status of the transportation system is not cancelled (e.g., on time or delayed), process 400 may continue to step 410.

As shown in FIG. 4, at step 408, process 400 may include cancelling an order. For example, passenger ordering system 102 may cancel an order based on a status of a transportation mode being cancelled. For example, passenger ordering system 102 may modify an order (e.g., cancel an order) based on a status of a transportation mode being cancelled. In some non-limiting embodiments or aspects, passenger ordering system 102 may send at least one communication to vendor system 106, delivery system 108, payment transaction system 110, and/or user device 112, the at least one communication comprising data cancelling the order.

As shown in FIG. 4, at step 410, process 400 may include determining whether a transportation mode status is delayed. In some non-limiting embodiments or aspects, passenger ordering system 102 may determine that a status of a transportation mode is delayed. For example, if passenger ordering system 102 determines a status of a transportation mode is delayed, process 400 may continue to step 412. If passenger ordering system 102 determines a status of a transportation mode is not delayed (e.g., on time), process 400 may continue to step 414.

As shown in FIG. 4, at step 412, process 400 may include delaying an order. For example, passenger ordering system 102 may delay an order based on a status of a transportation mode being delayed. For example, passenger ordering system 102 may modify an order (e.g., delay an order) based on a status of a transportation mode being delayed. In some non-limiting embodiments or aspects, passenger ordering system 102 may send at least one communication to vendor system 106, delivery system 108, payment transaction system 110, and/or user device 112, the at least one communication comprising data delaying the order.

As shown in FIG. 4, at step 414, process 400 may include determining that a location of order delivery has changed. In some non-limiting embodiments or aspects, passenger ordering system 102 may determine that a location of order delivery (e.g., location of departure gate, in-transit, or location of arrival gate) has changed. For example, passenger ordering system 102 may determine that a location of order delivery selected by the user (e.g., deliver at departure gate) has been changed (e.g., departure gate changed from Gate A1 to Gate B17).

As shown in FIG. 4, at step 416, process 400 may include modifying a location of order delivery. For example, after determining that a location of order delivery has changed, passenger ordering system 102 may modify a location of order delivery to a new location (e.g., new departure gate or new arrival gate).

As shown in FIG. 4, at step 418, process 400 may include receiving order delivery confirmation. For example, passenger ordering system 102 may receive order delivery confirmation from computer reservation system 104, vendor system 106, delivery system 108, and/or user device 112.

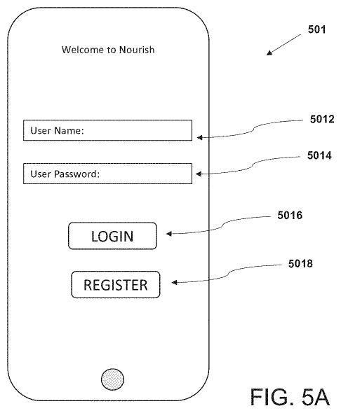

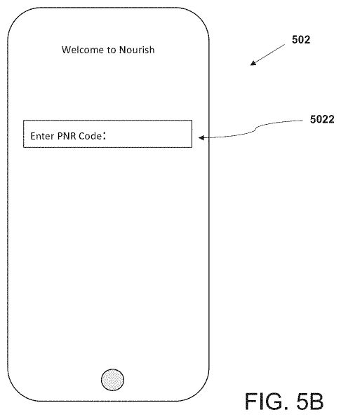

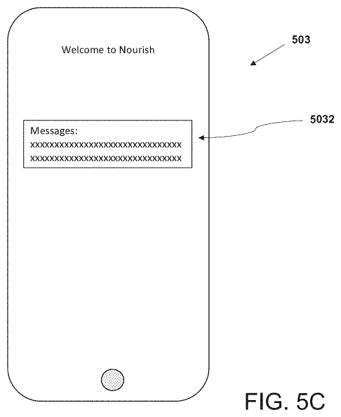

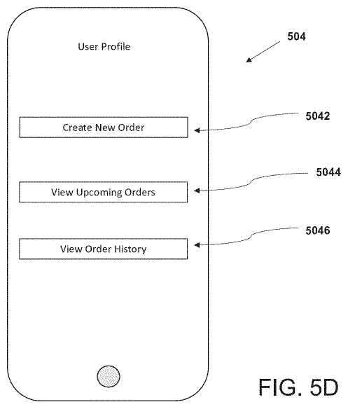

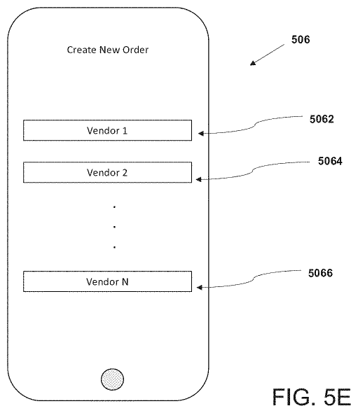

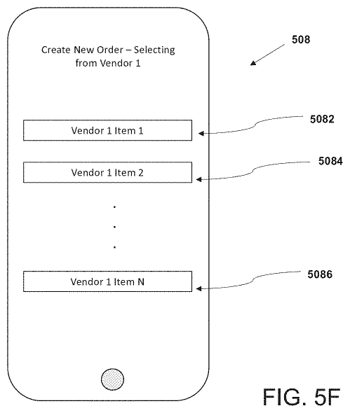

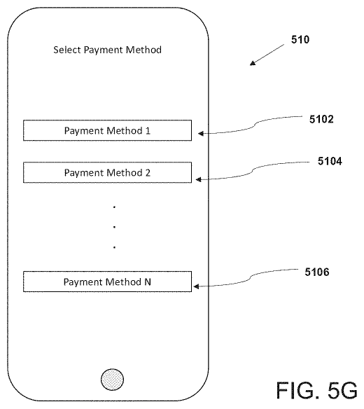

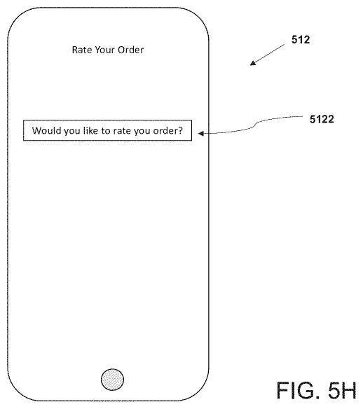

Referring now to FIG. 5A, shown is an exemplary diagram of GUI 501. As shown in FIG. 5A, GUI 501 may be an interactive GUI and may include one or input boxes 5012 and 5014 and selectable options 5016 and 5018. In some non-limiting embodiments or aspects, GUI 501 may be configured to receive at least one input and/or at least one selection from a user. In some non-limiting embodiments or aspects, GUI 501 may display data identifying one or more selections to login and access a user profile of a mobile application for passenger ordering system 102 and/or register as a new user of a mobile application for passenger ordering system 102.

Referring now to FIG. 5B, shown is an exemplary diagram of GUI 502. As shown in FIG. 5B, GUI 502 may be an interactive GUI and may include input box 5022. In some non-limiting embodiments or aspects, GUI 502 may be configured to receive at least one input from the user. For example, GUI 502 may be configured to receive at least one input from a user entering information into input box 5022 via user device 112. GUI 502 may be configured to be updated based on the user input.

Referring now to FIG. 5C, shown is an exemplary diagram of GUI 503. As shown in FIG. 5C, GUI 503 may include field 5032 for displaying a message to a user. The message to the user may be an alert, a reminder notification, and/or an order status update. In some non-limiting embodiments or aspects, GUI 503 may display data associated with at least one communication and/or a plurality of subsequent communications on user device 112. For example, GUI 503 may display a message to the user in field 5032.

Referring now to FIG. 5D, shown is an exemplary diagram of GUI 504. As shown in FIG. 5D, GUI 504 may be an interactive GUI and may include selectable options 5042, 5044 and 5046. In some non-limiting embodiments or aspects, GUI 504 may be configured to receive at least one user selection. In some non-limiting embodiments or aspects, GUI 504 may display data identifying one or more selections comprising options to create new order, view upcoming orders, and/or view order history on user device 112. For example, GUI 504 may be configured to receive at least one selection from a user to create new order when the user selects selection option 5042 (e.g., Create New Order). GUI 504 may be configured to be updated based on the user selection.

Referring now to FIG. 5E, shown is an exemplary diagram of GUI 506. As shown in FIG. 5E, GUI 506 may be an interactive GUI and may include selectable options 5062, 5064, and 5066. In some non-limiting embodiments or aspects, GUI 506 may be configured to receive at least one user selection. In some non-limiting embodiments or aspects, GUI 506 may display data identifying one or more selections for a vendor on user device 112. For example, GUI 506 may be configured to receive at least one selection from a user a category from a plurality of categories (e.g., a plurality of vendors) when the user selects option 5062 (e.g., Vendor 1). GUI 506 may be configured to be updated based on the user selection.

Referring now to FIG. 5F, shown is an exemplary diagram of GUI 508. As shown in FIG. 5F, GUI 508 may be an interactive GUI and may include selectable options 5082, 5084, and 5086. In some non-limiting embodiments or aspects, GUI 508 may be configured to receive at least one user selection. In some non-limiting embodiments or aspects, GUI 508 may display data identifying one or more selections for an item for purchase from at least one vendor of a plurality of vendors on user device 112. For example, GUI 508 may be configured to receive at least one selection from a user selecting an item from a plurality of items for purchase (e.g., a plurality food items and non-food items) when the user selects option 5082 (e.g., Vendor 1 Item 1). GUI 508 may be configured to be updated based on the user selection.

Referring now to FIG. 5G, shown is an exemplary diagram of GUI 510. As shown in FIG. 5G, GUI 510 may be an interactive GUI and may include selectable options 5102, 5104, and 5106. In some non-limiting embodiments or aspects, GUI 510 may be configured to receive at least one user selection. In some non-limiting embodiments or aspects, GUI 510 may display data identifying one or more selections for a payment option. For example, GUI 510 may be configured to receive at least one selection from a user to selecting payment method 1 from a plurality of payment methods (e.g., credit card, debit card, gift card, etc.) when the user selects option 5102 (e.g., Payment Method 1). GUI 510 may be configured to be updated based on the user selection.

Referring now to FIG. 5H, shown is an exemplary diagram of GUI 512. As shown in FIG. 5H, GUI 512 may be an interactive GUI and may include selectable options 5122. In some non-limiting embodiments or aspects, GUI 512 may be configured to receive at least one user selection. In some non-limiting embodiments or aspects, GUI 512 may display data identifying one or more selections to rate an order. For example, GUI 512 may be configured to receive at least one selection from a user to rating an order and/or a user experience with the mobile application for the order processing system. GUI 512 may be configured to be updated based on the user selection.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

The invention claimed is:

1. A method for placing an order in-transit comprising:
receiving, with at least one processor, at least one input from a user, the at least one input comprising at least a passenger name record (PNR) code, wherein the PNR code is an indication of a passenger reservation associated with a record in a database of a computer reservation system;
verifying, with the at least one processor, that the user is a confirmed passenger based on the PNR code;
providing, with the at least one processor, data identifying a plurality of selectable options of a mobile application for a passenger ordering system;
receiving, with the at least one processor, data identifying at least one selected option of the mobile application for the passenger ordering system;
associating, with the at least one processor, the PNR code with the at least one selected option;
generating, with the at least one processor, at least one order request, the at least one order request comprising data associated with the PNR code and the at least one selected option; and
sending, with the at least one processor, the at least one order request.

2. The method of claim 1, further comprising:
querying the database of the computer reservation system for data associated with the PNR code;
accessing a user itinerary associated with the PNR code;
generating at least one communication, wherein the at least one communication comprises data associated with the user itinerary, and wherein the at least one communication prompts the user to create an order; and
sending the at least one communication to the user.

3. The method of claim 2, further comprising:
displaying data associated the at least one communication via an interactive graphical user interface (GUI), the interactive GUI comprising at least one selectable option, wherein the interactive GUI is configured to receive the at least one selection from the user, and wherein the interactive GUI is configured to be updated based on receiving the at least one selection from the user.

4. The method of claim 1, further comprising:
authenticating, with at least one processor, the user for access to a user profile of the mobile application for the passenger ordering system, wherein verifying that the user is a confirmed passenger based on the PNR code is based on authenticating the user to access the user profile of the mobile application for the passenger ordering system.

5. The method of claim 1, further comprising:
receiving at least one communication, wherein the at least one communication comprises an order acceptance or an order rejection; and
updating a status of the order based on the at least communication.

6. The method of claim 1, further comprising:
receiving data comprising a real-time status of the order; and
displaying data comprising the real-time status of the order via a graphical user interface (GUI) of the mobile application for the passenger ordering system on a user device.

7. The method of claim 1, further comprising:
determining a change to a user itinerary;
determining a change to a status of a transportation mode based on the change to the user itinerary, wherein the status of the transportation mode comprises on of on time, delayed, and cancelled;
modifying an order based on the change to the status of the transportation mode, wherein modifying the order based on the change to the status of the transportation mode comprises:
delaying the order, based on the status of the transportation mode being delayed; or
cancelling the order, based on the status of the transportation mode being cancelled;
determining a change in a location for order delivery based on the change to the user itinerary, wherein a location for order delivery comprises one of location of departure gate, in-transit, and location of arrival gate; and
modifying the location for delivery based on the change to the user itinerary.

8. A system for placing an order in-transit comprising:
at least one processor programmed or configured to:
receive at least one input from a user, the at least one input comprising at least a passenger name record (PNR) code, wherein the PNR code is an indication of a passenger reservation associated with a record in a database of a computer reservation system;
verify that the user is a confirmed passenger based on the PNR code;
provide data identifying a plurality of selectable options of a mobile application for a passenger ordering system;
receive data identifying at least one selected option of the mobile application for the passenger ordering system;
associate the PNR code with the at least one selected option;
generate at least one order request comprising data associated with the PNR code and the at least one selected option; and
send the at least one order request.

9. The system of claim 8, wherein the at least one processor is further programmed or configured to:
query the database of the computer reservation system for data associated with the PNR code;
access a user itinerary associated with the PNR code;
generate at least one communication, wherein the at least one communication comprises data associated with the user itinerary, and wherein the at least one communication prompts the user to create an order ahead of an upcoming departure; and
send the at least one communication to the user.

10. The system of claim 9, wherein the at least one processor is further programmed or configured to:
display data associated the at least one communication via an interactive graphical user interface (GUI), the interactive GUI comprising at least one selectable option, wherein the interactive GUI is configured to receive the at least one selection from the user, and wherein the interactive GUI is configured to be updated based on receiving the at least one selection from the user.

11. The system of claim 8, wherein the at least one processor is further programmed or configured to:
authenticate the user for access to a user profile of the mobile application for the passenger ordering system, wherein verifying that the user is a confirmed passenger based on the PNR code is based on authenticating the user to access the user profile of the mobile application for the passenger ordering system.

12. The system of claim 8, wherein the at least one processor is further programmed or configured to:
receive at least one communication, wherein the at least one communication comprises an order acceptance or an order rejection; and
update a status of the order based on the at least one communication.

13. The system of claim 8, wherein the at least one processor is further programmed or configured to:
receive data comprising a real-time status of the order; and
display data comprising the real-time status of the order via a graphical user interface (GUI) of the mobile application for the passenger ordering system on a user device.

14. The system of claim 8, wherein the at least one processor is further programmed or configured to:
determine a change to a user itinerary;
determine a change to a status of a transportation mode based on the change to the user itinerary, wherein the status of the transportation mode comprises on of on time, delayed, and cancelled;
modify an order based on the change to the status of the transportation mode, wherein when modifying the order based on the change to the status of the transportation mode the at least one processor is further programmed or configured to:
delay the order, based on the status of the transportation mode being delayed; or
cancel the order, based on the status of the transportation mode being cancelled;
determine a change in a location for order delivery based on the change to the user itinerary, wherein a location for order delivery comprises one of location of departure gate, in-transit, and location of arrival gate; and
modify the location for delivery based on the change to the user itinerary.

15. A computer program product for placing an order in-transit comprising at least one non-transitory computer-readable medium including one or more instructions that, when executed by at least one processor, cause the at least one processor to:
receive at least one input from a user, the at least one input comprising at least one input comprising at least a passenger name record (PNR) code, wherein the PNR code is an indication of a passenger reservation associated with a record in a database of a computer reservation system;
verify that the user is a confirmed passenger based on the PNR code;
provide data identifying a plurality of selectable options of a mobile application for a passenger ordering system;
receive data identifying at least one selected option of the mobile application for the passenger ordering system;
associate the PNR code with the at least one selected option;
generate at least one order request, the at least one order request comprising data associated with the PNR code and the at least one selected option; and
send the at least one order request to at least one vendor of a plurality of vendors.

16. The computer program product of claim 15, wherein the one or more instructions further cause the at least one processor to:
query the database of the computer reservation system for data associated with the PNR code;
accessing a user itinerary associated with the PNR code;
generating at least one communication, wherein the at least one communication comprises data associated with the user itinerary, and wherein the at least one communication prompts the user to create an order;
sending the at least one communication to the user; and
display data associated the at least one communication via an interactive graphical user interface (GUI), the interactive GUI comprising at least one selectable option, wherein the interactive GUI is configured to receive the at least one selection from the user, and wherein the interactive GUI is configured to be updated based on receiving the at least one selection from the user.

17. The computer program product of claim 15, wherein the one or more instructions further cause the at least one processor to:
authenticate the user for access to a user profile of the mobile application for the passenger ordering system, wherein verifying that the user is a confirmed passenger based on the PNR code is based on authenticating the user to access the user profile of the mobile application for the passenger ordering system.

18. The computer program product of claim 15, wherein the one or more instructions further cause the at least one processor to:
receive at least one communication, wherein the at least one communication comprises an order acceptance or an order rejection; and
update a status of the order based on the at least one communication.

19. The computer program product of claim 15, wherein the one or more instructions further cause the at least one processor to:
receive data comprising a real-time status of the order; and
display data comprising the real-time status of the order via a graphical user interface (GUI) of the mobile application for the passenger ordering system on a user device.

20. The computer program product of claim 15, wherein the one or more instructions further cause the at least one processor to:
determine a change to a user itinerary;
determine a change to a status of a transportation mode based on the change to the user itinerary, wherein the status of the transportation mode comprises on of on time, delayed, and cancelled;
modify an order based on the change to the status of the transportation mode, wherein when modifying the order based on the change to the status of the transportation mode the one or more instructions further cause the at least one processor to:
delay the order, based on the status of the transportation mode being delayed; or
cancel the order, based on the status of the transportation mode being cancelled;
determine a change in a location for order delivery based on the change to the user itinerary, wherein a location for order delivery comprises one of location of departure gate, in-transit, and location of arrival gate; and
modify the location for delivery based on the change to the user itinerary.
